(19) United States
(12) Patent Application Publication
(10) Pub. No.: US 2016/0154946 A1
(43) Pub. Date: Jun. 2, 2016

(54) METHOD FOR ACQUIRING AND ANALYZING A LIST OF A PATIENT'S PRESCRIPTION MEDICATIONS

(71) Applicant: Reid M. RUBSAMEN, Alamo, CA (US)

(72) Inventor: Reid M. RUBSAMEN, Alamo, CA (US)

(21) Appl. No.: 15/014,783

(22) Filed: Feb. 3, 2016

Related U.S. Application Data
(63) Continuation of application No. 11/329,376, filed on Jan. 9, 2006.
Application No. 11/329,376 is a continuation-in-part of application No. 09/782,979, filed on Feb. 13, 2001, now abandoned.
(60) Provisional application No. 60/182,292, filed on Feb. 14, 2000.

(51) Int. Cl. G06F 19/00; H04L 29/08; H04L 29/06

(52) U.S. Cl. CPC G06F 19/3456; H04L 67/42; H04L 67/02; G06F 19/363

(57) ABSTRACT

A computer system for obtaining, analyzing and providing information to a community of user patients regarding their medication is disclosed. The system is provided by means of world wide web access and generates a user patient screen prompting the manual entry of data relating to the use patient and drugs being taken. The data are analyzed and results are provided to the user patient and/or the caregiver including drug-drug interactions, drug pricing, alternative medications and possible adjustments in the dosing regimen of the user patient.

### FIELD OF THE INVENTION

The present invention relates to a software method of acquiring and analyzing a list of prescription medications taken by patients. More particularly, to perform this acquisition and analysis using the Internet.

### BACKGROUND OF THE INVENTION

The Internet has enabled client-server based transactions to occur over a virtually unlimited geographical area. The client-server transaction allows small home computers to directly access programs and data on large remote computers. Web-based applications programs written in Hypertext Markup Language (HTML) allow people without specialized computer training to navigate through server environments at will. Because of the connectivity offered by the World Wide Web and the ease of use afforded by HTML applications which provide access to server functions, large databases containing specialized information are now available to a wider audience than ever before.

Two main activities currently taking place on the World Wide Web are commerce and education. The role of advertising in commerce has blended these two activities. In particular, a major objective of web based commercial enterprises is to attract visitors to the site where they can be exposed to advertisements educating them about the value of the site's products and services. The need to attract visitors to commercial sites has been so extreme, that some sites are actually paying customers either in cash or by providing goods and services at a discount so substantial that each sales event is associated with a net loss for the sellers.

Many patients who take medications are confused about the role of the individual drugs prescribed by their doctor, potential interactions between medications and recent advances in therapeutics which might make their current treatment regimen obsolete. Although a periodic review of a patient's entire medication regimen would be appropriate, this seldom occurs for a variety of reasons not the least of which is a lack of motivation by the patient and her physician. If patients or their physicians could be motivated to periodically subject their current pharmaceutical treatment regimen to scrutiny, safer and/or more efficacious therapy could result.

Much of the educational material disseminated to physicians and patients regarding drug therapy comes from the pharmaceutical industry. Drug companies spend considerable resources keeping detail representatives in the field whose primary responsibility is to teach physicians the potential benefits of the products sold by their employers. In addition, drug companies also spend large dollars on direct-to-patient advertising. These messages are necessarily indirect owing to regulatory restrictions regarding what can and cannot be said to patients about ethical (i.e. prescription) medications. A significant requirement for a detailed advertising campaign directed at patients is that the full package insert, including potential problems which may be associated with treatment with the drug being promoted, must accompany the advertisement.

These activities are expensive. In addition, much of this advertising is open loop and it is by no means certain that the desired target population has in fact been adequately addressed by the advertising campaign. Targeted marketing is the goal of these advertising campaigns. Patient profiling is the key to targeted marketing. The single most valuable descriptor of a patient who is undergoing treatment in the healthcare system is the list of medications which that patient is taking and, preferably, the dosing regimens for those medications. The present invention describes methods for acquiring this information from patients and analyzing it in a way so as to facilitate targeted marketing of specific pharmaceuticals to those patients.

### SUMMARY OF THE INVENTION

Two elements are essential to promote patient participation in supplying their list of prescription medications to a site. First, there must be returned value associated with disclosure of the list. Second, the process by which the list is entered must be simple. One value returned to the patient/user via the present invention is that a single drug can be proposed to the patient/user as a substitute for two or more drugs the patient/user is currently taking. The method of the invention achieves the simplification by not requiring the user/patient to enter a substantial amount of information. The information may be limited solely to the drugs the patient is taking.

Once the list of medications has been entered by the patient (the Patient Medication List) into the client application, the Hypertext Transfer Protocol is used by the client browser or other client application to upload the patient medication list into the server. A set of value functions is then applied to the list, giving the patient valuable information regarding their current therapy.

Specific value functions are being employed to encourage patients to communicate their complete list of current medications. These include (a) a list of potential drug-drug interactions which may complicate therapy (b) a scan of a wide variety of retail sources of the listed medications directing the patient to the lowest cost source for each drug (c) recent information from drug companies, government sources and publications regarding individual medications that the patient is taking (d) a comparison of the prescribed dosing regimen with the recommended dosing regimen for each of the patient's medications with a advisory if the prescribed regimen deviates from the dosing schedule recommended in, for example, the PDR monograph.

In addition to implementing the value functions, the server manages a database of pharmaceuticals for direct marketing (the Direct Marketing Medication List). Each of the named drugs in the Direct Marketing Medication List database contains named descriptors identifying the therapeutic class of the drug (Class Addition Descriptor), the drugs it could replace (Point Substitution Descriptor) and the combinations of drugs that it could replace (Group Substitution Descriptor). A Therapeutic Class Descriptor Database is also maintained allowing drugs from the Patient Medication List to be mapped into each drug's therapeutic class.

Value function (a) could help eliminate even obscure prescription errors from occurring. For example, the combination of meperidine with a mono-amine oxidase inhibitor as occurred in the highly publicized Libby Zion case at New York hospital in New York. Value function (b) could help patients effectively access the wide variety of Internet based retail sources of pharmaceuticals. Value function (c) could keep patients up to date on recent developments regarding their current medication or the therapeutic classes represented by their Patent Medication List, including newly discovered problems with their current therapy, clinical trials being conducted for drugs in the Patient Medication List or in the corresponding therapeutic class. Value function (d) could avoid problems such as the recent miss-transcription by a pharmacist of a hand written prescription which resulted in the dispensing of the wrong drug at the indicated dose resulting in the death of the patient.

A server-based program (Prescription Scan) then proceeds to parse the patient medication list as follows by associating with each drug in the Patient Medication List the therapeutic class of that drug. Then, the server-based application performs scans of both the Patent Medication List and the Direct Marketing Medication List, looking for the following matches:

### Point Substitution Match

A condition where a drug in the Patient Medication List is named in Point Substitution Descriptor of one or more of the drugs in the Direct Marketing Medication List.

### Group Substitution Match

A condition where more than one drug in the Patient Medication List appears in the Group Substitution Descriptor of one or more drugs in the Direct Marketing Medication List.

### Class Addition Match

A condition where one or more drugs in the Patient Medication List appears in the Class Addition Descriptor of one or more drugs in the Direct Marketing Medication List.

Drugs in the Direct Marketing Medication List resulting in a Point Substitution Match will be presented by Prescription Scan as possible candidates for replacing a specific drug in the Patient Medication List. Drugs in the Direct Marketing Medication List resulting in a Group Substitution Match will be presented as possible candidates to replace a group of drugs in the Patient Medication List. Drugs in the Direct Marketing Medication List resulting in a Class Addition Match will be presented as possible drugs for addition to the current therapeutic program represented by the Patient Medication List.

The presentation of drugs listed in the Direct Marketing Medication List by Prescription Scan is done graphically to re-enforce patient identification with the brands being recommended. In particular, a graphic representing the generic name, brand name, or logo of a drug, or a picture of the drug container or actual dosage form or a combination of these is shown in close proximity to the Patient Medication List. In the case of a Point Substitution Match, the recommended drug or drugs from the Direct Marketing List are presented next to the drug in the Patient Medication List for which the Point Substitution is being recommended. In the case of a Group Substitution Match, the recommended drug or drugs from the Direct Marketing List are presented next to the Patient Medication List with the group of drugs being recommended for replacement highlighted. In the case of the Class Addition Match, the recommended drug or drugs from the Direct Marketing List are presented under or above the group of drugs in the matched therapeutic class.

In each case, it is understood that “presenting” a drug from the Direct Marketing List means displaying a graphic of the drug logo, brand name, generic name, packaging or dosage form or a combination of these.

The drugs in the Patient Medication List and the Direct Marketing List need not be limited to prescription medications. Medications entered by the patient as well as medications in the Direct Marketing Medication List could contain so called nutriceuticals including herbal remedies, vitamins, and over the counter medications.

These and other objects, advantages, and features of the invention will become apparent to those persons skilled in the art upon reading the details of the invention as more fully described below.

### DETAILED DESCRIPTION OF THE INVENTION

Before the present systems are described, it is to be understood that this invention is not limited to particular systems or methodologies described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a User” includes a plurality of such Users and reference to “the measurement” includes reference to one or more measurements and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### INVENTION IN GENERAL

The invention includes a method carried out by a computer system which implements a data receptor form on a screen which is accessible to a community of users. The method analyzes data on a patient's prescribed pharmaceuticals. The method comprises the computer implemented steps of:

(a) providing access to a community of user patients;

(b) generating a screen for user/patient access wherein the screen prompts the user/patient to manually enter data relating to drugs being taken by the user/patient;

(c) obtaining data manually entered by the user/patient as prompted wherein the data may be strictly limited to only the medications taken by the patient;

(d) analyzing the data manually entered by the user/patient; and

(e) producing a result based on the analysis.

The results are the value provided back to the user in exchange for entering very limited information which may be limited strictly to the drugs currently taken by the patient. The results can include advising the patient of potential adverse interactions of two or more drugs being taken by the patient. The potential danger from the adverse reaction may be rated by the method in multiple levels. For example, a dangerous drug interaction may be rated as (1) extremely high risk; (2) high risk; and (3) moderate risk. The drug interaction results may be listed first and highlighted due to the potential health risks to the user/patient.

Additional results may provide the patient/user with access to a variety of internet based resources for pharmaceuticals which are the same as or equivalent to the drugs listed by the patient. This list of resources may indicate that the drugs listed by the patient can be obtained at the lowest possible cost at a point of sale within a given radius of distance from the user/patient or on an internet site. Information may also be provided about the potential risks of substituting a generic for brand name product in certain circumstances.

An additional result which may be provided by to the patient/user is information relating to current developments for clinical studies involving the medication used by the patient/user or closely related to that used by the patient/user. This information may list adverse responses reported by others taking the drug listed by the patient/user. Further, the results may indicate modifications in the treatment protocol which will help eliminate or at least reduce the adverse responses.

Yet another result which may be provided to the user/patient is specific information on the drug and what the drug is generally used for treating. This information may be provided in order to determine if there has been a mistranscription by the pharmacist who may have dispensed the wrong drug based on the prescription written by the doctor. Warnings could be provided in this response to confirm that the patient is suffering from one or more of the indications which this drug is generally prescribed for.

### INFORMATION ON MEDICARE

The computer system of the invention takes into account Medicare Part D which provides prescription benefits for patients. In view of Medicare Part D private healthcare plans have been developed which provide products that deliver benefits to patients. There is currently a large field of providers and users must choose from those providers. The users need to compare and contrast the available options and to do so can refer to the Medicare website at MediCare.gov.

The selection problem faced by the user/patient is confounded by the fact that different patients will benefit differently from different providers. Thus, the provider which is the best for one patient may not be the best for another and the provider which best suits a particular patient is based on the patient's diagnosis as well as the drugs needed by that patient. For example, a chemotherapy patient may need very expensive drugs for a short period of time whereas a diabetes patient may require moderately priced drugs for their entire life. One healthcare provider may be more beneficial to the chemotherapy patient whereas another provider may be more beneficial to the diabetic patient.

The computer driven methodology of the invention which is referred to as SCRIP-SCAN system relies on value functions to encourage patients to provide a complete list of medications to the website database. One of the value functions provided is assisting the patient to find the least expensive source for the drugs that they seek. By compiling a list of the patient's medication and combining this data with patient-provided information regarding the price paid and the patient satisfaction with the benefit provider, a database can be compiled. That database allows multivariant analysis in order to determine the best benefit provider based on the patients drugs which will be needed over a short term or long term as well as the diagnosis of the patient with respect to diseases or conditions they have.

In an aspect of the invention the user/patient enters information on (1) each of the drugs currently taken by the patient; (2) the cost paid for each of the drugs in a per unit basis; (3) the healthcare provider which may be a Medicare Part D provider; and (4) the user patient's degree of satisfaction with the healthcare provider. The degree of satisfaction may be ranked as positive neutral or negative or may be ranked as a number based on a scale from the highest positive of 10 to the lowest of 1 or any other ranking system. The SCRIP-SCAN system of the invention then takes the information entered by the patient and within a data base uses a multivariant analysis in order to find a correlation between satisfaction, cost and the healthcare provider with the drugs and diagnosis of the patient. Information is then provided back to the patient in a form which gives the patient a better idea with respect to which healthcare provider will provide the best benefits to the patient in terms of the highest reimbursement to the patient for the drugs being taken.

In an aspect of the invention the patient can also provide information on whether the patient is interested in paying the lowest possible premiums to a benefit provider or obtaining the lowest possible deductible. It is understood that some patients will pay a higher premium in order to obtain a lower deductible whereas other patients are willing to pay a high deductible in return for paying a low premium to the healthcare provider. This information can be correlated by the system along with the drugs being taken by the patient in order to match the patient with the best healthcare provider based on the needs of the patient.

Based on the above it can be understood in that the SCRIP-SCAN analysis will be dynamic in the sense that optimal recommendations for a patient with a specific diagnosis and a particular list of required drugs will change over time. That change will be based on factors including changes that benefit providers provide in their offerings, new medications becoming available and changes in government funding policies.

The SCRIP-SCAN system of the invention provides for the opportunity to deliver to the patient a daily, weekly, monthly, quarterly or yearly recommendation regarding places where drugs can be purchased and benefit providers which will be the most effective for the particular user based on the drugs they are taking and the diagnosis. Although the system can allow for the entry of additional information much of the data provided by the SCRIP-SCAN system can be provided back to the patient merely by their entering only the list of medications they are taking. Specifically, the results of multivariant analysis in the database makes recommendations based on the patient's diagnosis or multiple diagnosis or on the actual drugs themselves, depending on the strength of the correlation determined from the multivariant analysis performed on the resident data.

Multivariate statistics or multivariate statistical analysis in statistics describes a collection of procedures which involve observation and analysis of more than one statistical variable at a time.

There are many different models, each with its own type of analysis:

Canonical correlation analysis tries to establish whether or not there are linear relationships among two sets of variables (covariates and response).

Regression analysis attempts to determine a linear formula that can describe how some variables respond to changes in others. The general linear model is a form of regression analysis.

Principal components analysis attempts to determine a smaller set of synthetic variables that could explain the original set.

Discriminant function or canonical variate analysis attempt to establish whether a set of variables can be used to distinguish between two or more groups.

Multidimensional scaling covers various algorithms to determine a set of synthetic variables that best represent the pairwise distances between records. The original method is principal coordinate analysis.

Linear discriminant analysis (LDA) computes a linear predictor from two sets of normally distributed data to allow for classification of new observations.

Logistic regression allows to perform a regression analysis to estimate and test the influence of covariates on a binary response.

Multivariate analysis of variance (MANOVA) methods extend analysis of variance methods to cover cases where there is more than one dependent variable and where the dependent variables cannot simply be combined.

### DATA PROCESSING

Data processing on the Internet is characterized by the client-server model. Large server systems continuously attached to the World Wide Web via high bandwidth connections contain application programs written using Hypertext Markup Language (HTML) accessible via unique addresses called Uniform Resource Locators (URLs). Client side systems have traditionally been personal computers running application programs called browsers, which allow communication between client and server via Hypertext Transfer Protocol (HTTP). The advent of generally available high speed wired and wireless connection between client and server systems has caused the computing paradigm to shift from local execution of self contained programs operating on local data to running server based application programs operating on server-based data or even on data resident throughout the world wide web.

This paradigm shift from local to remote data processing has decreased the requirement for computational resources at the client environment. As a result, clients able to communicate across the World Wide Web to servers now include small hand held computers, personal data assistants (PDAs), cellular telephones, and other wireless and wired portable communication technologies.

The client interface is by no means limited to a browser application program. Client-based application programs can seamlessly connect to the Internet and make use of information stored on the World Wide Web completely transparent to the end user.

Those skilled in the art could make and use the present invention using the disclosure described herein. However, in order to supplement such a disclosure particularly with respect to systems and computers used in connection with the present invention applicants incorporate by reference in their entirety the following U.S. Patents: U.S. Pat. No. 5,950,630, issued Sep. 14, 1999 entitled System and Method for Improving Compliance of a Medical Regiment; U.S. Pat. No. 5,845,255, issued Dec. 1, 1998 entitled Prescription Management System; U.S. Pat. No. 5,737,539, issued Apr. 7, 1998 entitled Prescription Creation System; U.S. Pat. No. 3,979,839, issued Sep. 14, 1976 entitled Drug Interaction System; U.S. Pat. No. 5,642,731, issued Jul. 1, 1997 entitled Method of and Apparatus for Monitoring the Management of Disease; U.S. Pat. No. 5,823,948, issued Oct. 20, 1998 entitled Medical Records, Documentation, Tracking and Order Entry System; U.S. Pat. No. 5,883,370, issued Mar. 16, 1999 entitled Automated Method for Filling Drug Prescriptions; U.S. Pat. No. 5,963,136, issued Oct. 5, 1999 entitled Interactive Prescription Compliance and Life Safety System; and U.S. Pat. No. 5,950,632, issued Sep. 14, 1999 entitled Medical Communication Apparatus, System, and Method.

The increasing breadth of technology capable of interfacing to the Internet enables multiple potential ways in which the Patient Data List can be entered into the server where the Prescription Scan application is resident. The Patient Data List could be manually entered one drug at a time using drug name, dosage size and dosing frequency. This process could be simplified through the use of a unique multi-digit code, which carried all of this information for each drug being taken. The process cold be automated via a bar code on each medication bottle which could be scanned by a bar code reader attached to the patient's computer or a Personal Data Assistant (PDA, e.g. 3com Palm Pilot). The process of entering medications in the Patient Data List into the Prescription Scan application could be completely automated through the use of a “Smart Medicine Cabinet” which reads machine readable labels, solid state digital memories or receives RF signals from transmitters attached to each medicine bottle. In this way, Prescription Scan is automatically updated each time a new medication bottle is placed into the medicine cabinet.

The electronic medicine cabinet disclosed and described herein could be produced using the technology known to those skilled in the art in combination with the description and disclosure provided here. However, in order to supplement such disclosure applicants incorporate by reference in their entirety the following U.S. Patents: U.S. Pat. No. 5,950,632, issued Sep. 14, 1999 entitled Medical Communication Apparatus System, and Method; U.S. Pat. No. 5,431,299, issued Jul. 11, 1995 entitled Medication Dispensing and Storing System with Dispensing Modules; U.S. Pat. No. 5,495,961, issued Mar. 5, 1996 entitled Portable Programmable Medication Alarm Device and Method and Apparatus for Programming and Using the Same; U.S. Pat. No. 5,713,485, issued Feb. 3, 1998 entitled Drug Dispensing System; U.S. Pat. No. 5,797,515, issued Aug. 25, 1998 entitled Method for Controlling a Drug Dispensing System; U.S. Pat. No. 5,912,818, issued Jun. 15, 1999 entitled System for Tracking and Dispensing Medical Items ; U.S. Pat. No. 5,993,046, issued Nov. 30, 1999 entitled System for Dispensing Medical Items by Brand or Generic Name; and U.S. Pat. No. 4,847,764, issued Jul. 11, 1989 entitled System for Dispensing Drugs in Health Care Institutions.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

1. In a computer system which implements a data receptor form on a screen which is accessible to a community of users, a method of analyzing data on a patient's prescribed pharmaceuticals, the method comprising the computer implemented steps of:
(a) providing user access to a community of user patients;
(b) generating a screen for user patient access wherein the screen prompts the user patient to manually enter data relating to drugs being taken by the user patient;
(c) obtaining data manually entered by the user patient as prompted;
(d) analyzing the data manually entered by the user patient;
Producing a result based on the analysis; and
wherein the results of the analysis provide the user with information on a single drug which may be substituted for two or more drugs currently taken by the patient;
further wherein the results provide the user with retail sources of the drugs being taken by the patient;
still further wherein the results provide the user with information on recent developments regarding their current medication or related medications including recently reported adverse response and positive results obtained in clinical trials; and
further wherein the results provide information on potential drug interactions with rated levels of warning based on the potential severity of the drug interaction; and
(f) sending the results to the user,
wherein the manually entered data further includes costs of the drugs on a per unit basis and wherein the data is compared against a data bank of drugs and the results of the analysis describes alternative drugs for treating the user patient and any lower cost sellers of the drug; and
wherein the system is a software-based system manually entered data compared against a data bank family of drug sellers and the results of the analysis describes prices for the drugs being taken by the user patient.

2-6. (canceled)

7. The method of claim 1, wherein the user access is provided by means of world wide web access and the manually entered data comprises user name, age, sex, weight, height, race, current medications, medication dosages, time of meals, food eaten at meals, symptoms, insurance and caregiver name,
wherein the manually entered data further includes a rating by the user patient on their satisfaction with their benefits provider and wherein results further include proposing a benefits provider to the user; and
wherein the benefits provider is proposed based on the drugs taken by the user being matched with a benefits provider likely to give the user the best benefits based on the drugs taken by the user.

8-9. (canceled)

10. The method of claim 1, wherein the system is a browser-based system and the data entered by the patient relating to drugs being taken by the user patient is analyzed relative a data bank of information on drugs.

11. The method of claim 10, wherein the results of the analysis provides the user with one or more benefits provides.

12. The method of claim 11, wherein the results of the analysis describe information on the effective shelf life of drugs being taken by the user patient.

13. The method of claim 1, wherein the manually entered data comprise a list of drugs taken by the patient which list is compared against a data bank of health care providers to determine the best benefits paid on the list of drugs and provides a list of potential drug interactions, possible drug sellers and possible alternative treatments.

14-17. (canceled)

18. The method of claim 1, wherein the results of the analysis describes alternative drugs to those being taken by the user patient along with information on the price, potential benefits and potential adverse effects of the alternative drugs.

19. The method of claim 1, wherein the results of the analysis describes a single drug which could be substituted for two or more drugs currently being taken by the user patient.

20. The method of claim 1, wherein the results of the analysis describe a specific therapeutic class for each drug being taken by the user patient and lists other currently available drugs in each class and wherein data is manually entered using a bar code reader and scanning a bar code on a medication of the user patient.

21. The method of claim 20 wherein the results produced comprises a display on the user patient's screen of the medication along with the name of the medication and its most common use thereby allowing the user patient to confirm a druggist has provided the corrected medication and that the medication is for an indication for which the user patient is being treated.

22. (canceled)

23. The method of claim 1, further comprising:
connecting the system to a pharmacy computer and comparing manually entered data of the user patient against pharmacy computer data on the user patient.

24. The method of claim 1, further comprising:
connecting the system to a plurality of pharmacy computers to obtain information on pricing of medication of the user patient.

25. The method of claim 1, further comprising:
connecting the system to a remote pharmacy computer and obtaining information on possible adverse drug interactions on drugs being prescribed to the user patient.

26. The method of claim 1, further comprising:
storing drug containers for the drugs being taken by the user patient in an electronic medicine cabinet comprising a means for entering data inscribed on the container and uploading the data to the system.

27. (canceled)

28. In a computer system which implements a data receptor form on a screen which his accessible to a community of users, a method of analyzing data on a patient's prescribed pharmaceuticals, the method comprising the computer implemented steps of:
(a) providing a community of users with access to the computer system using word wide web access;
(b) generating a screen for user patient access wherein the screen prompts the user patient to manually enter data relating to the drugs being taken by the user patient;
(c) obtaining data manually entered by the user patient as prompted wherein the data comprises a list of drugs currently taken by the user patient;
(d) analyzing the manually entered list of drugs against a databank of potential healthcare providers in order to determine one or more healthcare providers which provide the highest benefits on the drugs listed by the user patient; and
(e) producing a result based on the analysis; and
(f) sending the result to the user patient
wherein the results of the analysis describe recent changes in benefits provided by benefits providers; and
further wherein the results comprise current information on government funding policies relating to prescription drug reimbursement.

29. The method of claim 28, wherein the results of the analysis describe new medications which become available and may be substituted for drugs in the list manually entered by the patient.

30. The method of claim 28 wherein a user patient profile is generated using the manually entered data and wherein the results obtained describe alternate medications and an alternate dosing regimen based on the user patient profile.
